(19) United States
(12) Patent Application Publication
(10) Pub. No.: US 2005/0243002 A1
(43) Pub. Date: Nov. 3, 2005

(54) Decorative antenna for automobile

(76) Inventor: Yiu Wa Hung, Hong Kong (CN)

Correspondence Address: SUGHRUE MION, PLLC, 2100 PENNSYLVANIA AVENUE, N.W., SUITE 800, WASHINGTON, DC, 20037, US

(21) Appl. No.: 10/953,739

(22) Filed: Sep. 30, 2004

(30) Foreign Application Priority Data
Apr. 30, 2004 (CN) 200420045398.2

(51) Int. Cl. H01Q 1/32

(52) U.S. Cl. 343/711

(57) ABSTRACT

A decorative antenna for automobile emitting light when the automobile is moving comprises a case, a luminotron connected with leads and a mini wind-driven generator. The case may be formed as a toy such as a helicopter. The case is provided with a transparent window thereon and a mounting hole matching the automobile antenna. When the automobile is moving, the mini wind-driven generator generates electricity and supplies power to the luminotron, thus actuating the luminotron to emit light and function as an ornament. A wireless receiver and a rechargeable battery are provided in the case, a remote controller is further provided. The mini wind-driven generator charges the rechargeable battery and supplies the power to the luminotron, the rechargeable battery supplies power to the receiver connected to the luminotron. The luminotron is actuated to emit flash light when the wireless receiver receives signals sent from the remote controller by the automobile owner. When the automobile is moving, the decorative antenna for automobile according to the present utility model will emit light and function as an ornament. When the automobile is parked, flash light emitted from the ornament could indicate the position of the automobile, thus making an automobile owner easily find his automobile in a large parking lot.

### TECHNICAL FIELD

The present utility model relates to a decorative antenna for automobile, more particularly, to a decorative antenna for automobile which could emit light when the automobile is moving. After being modified in some sort, the decorative antenna for automobile of the present utility model also could be used as an automobile searching pager which could indicate the position of an automobile in a parking lot by means of a short range wireless paging.

### TECHNICAL BACKGROUND

Automobiles are the second homes for many automobile owners. Therefore, many ornaments are used by the owners to decorate their automobiles. Most of these ornaments are used inside the automobiles, which could only be enjoyed by the owners but not be shared by the others and just serves the function of decorating. In addition, because the same type automobiles have the same externality, it is difficult for the owners to distinguish and find their automobiles in large parking lots (indoor or outdoor) at night or in foggy days which have lower visibility.

### SUMMARY OF THE UTILITY MODEL

A first object of the present utility model is to provide a decorative antenna for automobile which is installed outside the automobile and could flash.

A second object of the present utility model is to provide a decorative antenna for automobile which may function as a sign after being further modified in order that automobile owners could find their automobiles with great speed.

In order to achieve the above-mentioned first object, a decorative antenna for automobile according to the present utility model comprises a case, a luminotron connected with leads and a mini wind-driven generator. The case may take various shapes or is formed as a cartoon toy. The case is provided with a transparent window thereon and a mounting hole which matches the automobile antenna to be mounted thereon.

The ornament is fixedly mounted on the automobile antenna in use. When the automobile is moving, the mini wind-driven generator generates electricity and supplies power to the luminotron, so that the luminotron emits light and serves the function of an ornament.

In order to achieve the above-mentioned second object, the present utility model is modified based on the above scheme as follows: a wireless receiver and a rechargeable battery are provided in the case, a remote controller is further provided, the mini wind-driven generator charges the rechargeable battery and supplies the power to the luminotron, the rechargeable battery supplies power to the receiver whose control signal output terminal is connected to the luminotron; the wireless receiver uses universal remote control receiving module which and demodulate and magnify the received signals and output a control signal to actuate the luminotron to flash.

The luminotron will not flash when the automobile is parked in a parking lot. Only when the receiver receives the signal having a corresponding frequency sent from the matching remote transmitting module by the driver, the luminotron is actuated to flash.

The decorative antenna for automobile according to the present utility model will flash when the automobile is moving, thus providing a decorating function. After the function is expanded, light emitted from the ornament could show the position of the automobile at night, thus making an automobile owner easily find his automobile in a large parking lot.

### BRIEF DESCRIPTION OF THE DRAWINGS

FIG. 1 is a schematic view showing an elementary structure of the first embodiment of the present utility model;

FIG. 2 is a schematic view showing an elementary structure of the second embodiment of the present utility model.

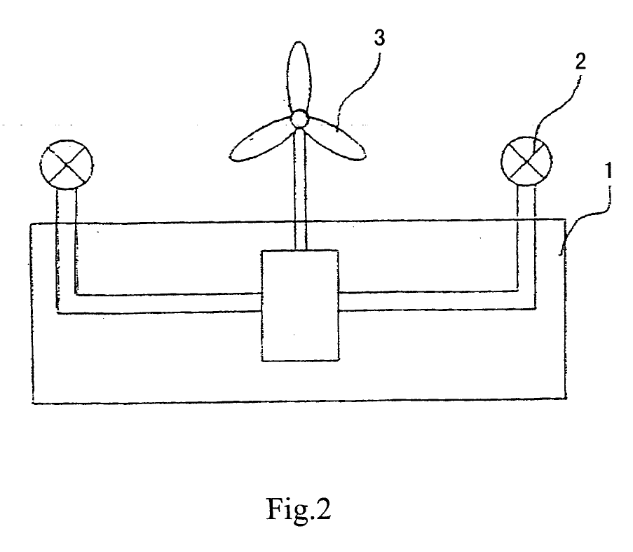

in the drawings:

1: a case; 2: a luminotron; 3: a mini wind-driven generator; 4: a rechargeable battery; 5: a wireless receiver; 6: a remote controller.

### DETAILED DESCRIPTION OF THE EMBODIMENTS

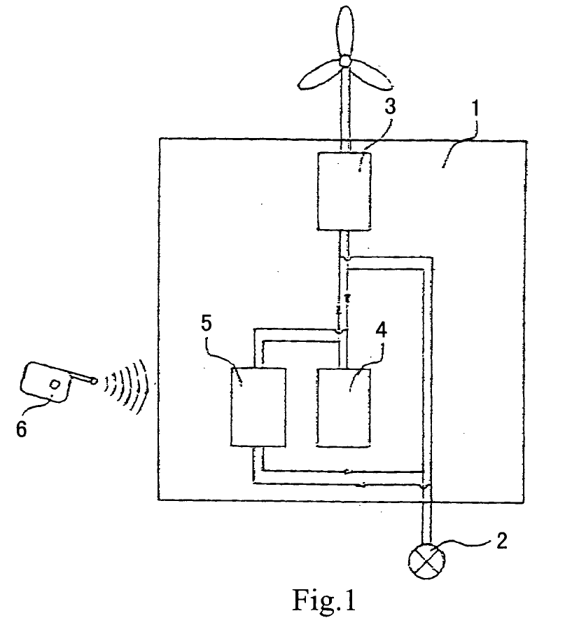

As shown in FIG. 1, the decorative antenna for automobile according to the first embodiment of the present utility model comprises a case 1, a luminotron 2 connected with leads and a mini wind-driven generator 3. The case may take various shapes or is formed as a cartoon toy, such as a helicopter. The rotor vane or the tail vane of the helicopter could drive the electrical generator in the helicopter and supply power to the luminotron. Light emitted from the luminotron passes through the transparent porthole of the helicopter and radiate out of the helicopter. A mounting hole is provided on the landing chassis of the helicopter so as to fix the helicopter on the automobile antenna. When the automobile is moving, the rotor vane or the tail vane of the helicopter is rotated by the wind and flash light will be emitted from inside of the porthole so as to provide a function of an ornament.

Some modifications could be made based on the above scheme to improve the function of the present utility model. A wireless receiver and a rechargeable battery are provided in the case, a remote controller is further provided. The mini wind-driven generator charges rechargeable battery and supplies the power to the luminotron, the rechargeable battery supplies power to the receiver whose control signal output terminal is connected to the luminotron. The wireless receiver uses universal remote control receiving module which can demodulate and magnify the received signals and output a control signal so as to actuate the luminotron to flash.

The luminotron will not flash when the automobile is parked in a parking lot. Only when the receiver receives the signal having a corresponding frequency sent from the matching remote transmitting module by the driver, the luminotron is actuated to emit flash light.

1. A decorative antenna for automobile, characterized in that it comprises a case (1), a luminotron (2) connected with leads, and a mini wind-driven generator (3), said case can be formed as various ornaments having a transparent window thereon, and a mounting hole which matches the automobile antenna is provided on said case.

2. The decorative antenna for automobile of claim 1, characterized in that a wireless receiver (4) and a rechargeable battery (5) are provided in the case (1), and a remote controller (6) is further provided, the mini wind-driven generator (3) charges the rechargeable battery and supplies power to the luminotron, the rechargeable battery supplies power to the receiver whose control signal output terminal is connected to the luminotron; the wireless receiver uses universal remote control receiving module which can demodulate and magnify the received signals and output a control signal so as to actuate the luminotron to emit flash light.
